(19) United States
(12) Patent Application Publication
(10) Pub. No.: US 2008/0226451 A1
(43) Pub. Date: Sep. 18, 2008

(54) Wedge shaped wind boosters

(76) Inventor: Frank James Tatar, Blasdell, NY (US)

Correspondence Address: FRANK JAMES TATAR, 2053 Electric Avenue, Blasdell, NY, 14219, US

(21) Appl. No.: 11/716,885

(22) Filed: Mar. 12, 2007

(51) Int. Cl. F03D 3/06

(52) U.S. Cl. 416/132 B

(57) ABSTRACT

A plurality of wedge shaped wind boosters on the interior of the curved panel wind sails of a vertical axis windmill, located on a vertical steel tower producing power produced by the electric generator located in the generating room of tower at ground level.

U.S. Pat. No. 546,903 is incorporated by reference to this application and the relationship between past application is that it was for the vertical axis windmill in its entirety. The current application is for the invention of the wedge shaped wind boosters used on the curved wind sails of a vertical axis windmill. The vertical axis windmill features a plurality of curved panel wind sails and the plurality of wedge shaped wind boosters located on the interior of the curved wind sails produce more torque to drive the permanent magnet electric generator to generate electric power. And, because each panel has a wedge shaped wind booster it will minimize resistance on the revolving wind sails, producing electricity from the vertical axis windmill more efficiently. The process of making wedge shaped wind boosters is from aluminum, steel, or other material with a bending machine and the wedge shaped wind boosters are attached to the polarity of the interior curved vertical axis wind sails/panels of the vertical axis windmill. As shown in the single drawing submitted, the top of the page is the top view, a plurality of wedge shaped wind boosters 2 are attached to a plurality of curved panel wind sails 3 are attached to spars 4 and 5 attached to shaft 6 that drives the electric producing generator.

### BACKGROUND OF THE INVENTION

The field of endeavor to which the invention pertains is to generate electricity from wind power. There is no information known to me, including references to specific documents that is related to my invention. In addition, I cannot refer to specific problems involved in the prior art (or state of technology) which my invention is drawn because to our knowledge and research there is no other specific or related existence of wedge shaped wind boosters.

### BRIEF SUMMARY OF THE INVENTION

The invention is the wedge shaped wind boosters used on the interior curved wind sails/panels of the vertical axis windmill to produce a large to enormous amount of torque produced by the wind to produce electricity.

### BRIEF DESCRIPTION OF THE DRAWINGS

The present invention and the manner in which it may be practiced is further illustrated with reference to the accompanying drawings wherein:

FIG. 1 is a top perspective view of a vertical axis windmill having a plurality of curved panel wind sails and a plurality of wedge shaped wind boosters of the present invention located on the interior of the curved panel wind sails.

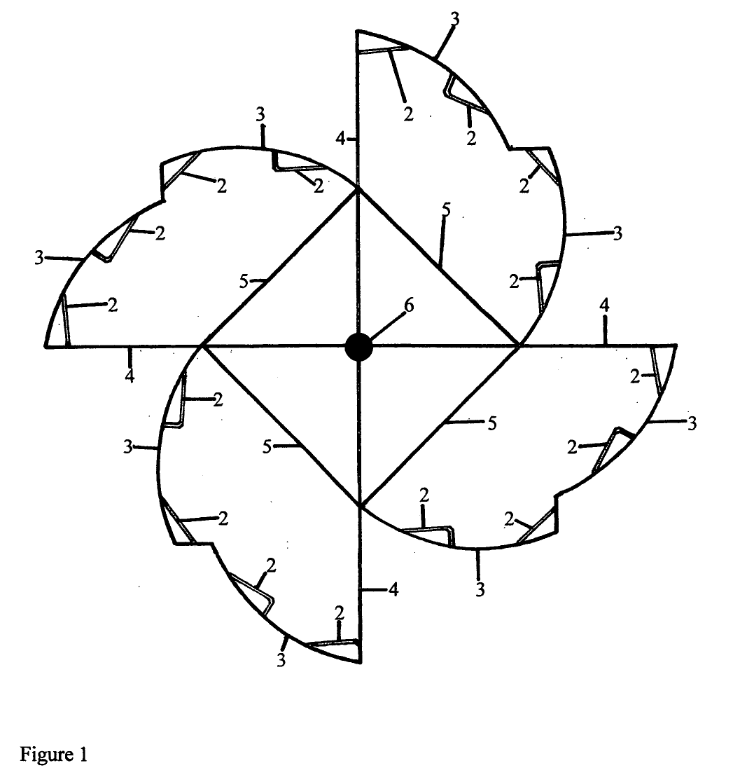

### DETAILED DESCRIPTION OF THE INVENTION

The invention is the wedge shaped wind boosters. As shown in the single drawing submitted, the top of the page is the top view, a plurality of wedge shaped wind boosters 2 are attached to a plurality of curved panel wind sails 3 are attached to spars 4 and 5 attached to shaft 6 that drives the electric producing generator. There is a multiple assembly of curved panels referred to as wind sails on a vertical axis windmill. Each panel, on the interior (can be multiple), will have a wedge shaped wind booster to minimize resistance on the revolving wind sails. The wedge shaped wind boosters have a flat panel at the rear part of the wind booster to capture more wind for more torque. The wind sails are mounted on spars that are attached to the drive shaft that operates the electric generator to produce electric current. The wind sails are vertical revolving horizontally in a vertical steel tower. The wind does not see the wedge shaped wind boosters until they come into view. The wind sails rotate horizontally, clockwise and can be made of steel, aluminum, plastic, wood or other materials and capture the wind from any direction due to the curvature of the wind sails. Any number of boosters can be added on the interior of the wind sails of each wind sail.

What I claim as my invention is:

1. A plurality wedge shaped wind booster used on curved wind sails of a vertical axis windmill to minimize resistance on the rotating panel wind sails to produce more torque power to drive an electric generator for a vertical axis windmill to produce a large amount of electricity, more efficiently; whereas the wedge shaped wind boosters are tapered with the leading edge of the wind boosters lying flat against the wind sail and gradually tapered so that the rear of the wedge shaped boosters have a wall extending from the wind sails the wedge shaped boosters can be of any size width and length of the entire wind sails.
